(19) United States
(12) Patent Application Publication
(10) Pub. No.: US 2026/0278353 A1
(43) Pub. Date: Sep. 17, 2026

(54) METHOD AND SYSTEM FOR PROCESSING DATA THROUGH QUANTIZED LARGE MODELS

(71) Applicant: L&T TECHNOLOGY SERVICES LIMITED, Chennai (IN)

(72) Inventors: VIKRAM SUBRAMANI, Krishnagiri (IN); SUDHIR BHADAURIA, Ahmedabad (IN); KAVIPRIYA BALASANKAR, Cuddalore (IN); MADHUSUDAN SINGH, Bangalore (IN)

(21) Appl. No.: 19/220,205

(22) Filed: May 28, 2025

(30) Foreign Application Priority Data
Mar. 11, 2025 (IN) 202541022096

(51) Int. Cl. G06N 3/0495; G06N 3/08

(52) U.S. Cl. CPC G06N 3/0495; G06N 3/08

(57) ABSTRACT

This disclosure relates to method and system for processing data through quantized large models. The method may include providing input data to a quantized large model. The method may further include retrieving a plurality of encoded parameters from a pre-stored encoded parameter file for the quantized large model in response to receiving the input data. The method may further include processing, via the plurality of bit-linear layers, the input data through the associated predefined rule-based linear operation based on the plurality of encoded parameters in the encoded parameter file. The method may further include generating, via the quantized large model, an output corresponding to the input data based on the processing.

### TECHNICAL FIELD

This disclosure relates generally to large models, and more particularly to method and system for processing data through quantized large models.

### BACKGROUND

Quantization is a process through which precision of data types associated with weight values and activation values of a large model may be reduced. By way of an example, a 32-bit floating point (FP32) value may be converted to an 8-bit integer (INT8) value or a 1-bit binary value. Quantization process is used to minimize model size, reduce memory bandwidth, and enable faster inference through processors.

In the present state of art, 1-bit large model quantization involves reducing the precision of weight values to one of −1 or 1. However, the reduced precision weight values may still be stored in a higher precision value format (i.e., FP32) for compatibility with hardware and software frameworks (for example, PyTorch). Thus, storage and processing through such quantized large models may still require an overhead of the higher precision value format, negating some of the benefits of quantization in terms of reduced memory usage and faster computation. Additionally, some commonly used layers for dense multiplication in neural networks (for example PyTorch's ‘torch.nn.Linear’), may only support higher precision data types (for example, float 32 or float 16) for storage of weight and computation making it impossible to directly leverage true 1-bit arithmetic within the layer. As a result, even for the quantized large model, operations may still occur in higher precision data type, limiting the full potential; of quantization for optimizing performance and efficiency.

Thus, the present invention is directed to overcome one or more limitations stated above or any other limitations associated with the known arts.

### SUMMARY

In one embodiment, a method for processing data through quantized large models is disclosed. In one example, the method may include providing input data to a quantized large model. The quantized large model is obtained from a large model through quantization aware training based on a quantization technique and the quantized large model may include a plurality of bit-linear layers, each configured for performing a predefined rule-based linear operation. The method may further include retrieving a plurality of encoded parameters from a pre-stored encoded parameter file for the quantized large model in response to receiving the input data. The plurality of encoded parameters corresponds to the plurality of quantized parameters. The method may further include processing, via the plurality of bit-linear layers, the input data through the associated predefined rule-based linear operation based on the plurality of encoded parameters in the encoded parameter file. The method may further include generating, via the quantized large model, an output corresponding to the input data based on the processing

In one embodiment, a system for processing data through quantized large models is disclosed. In one example, the system may include a processor and a computer-readable medium communicatively coupled to the processor. The computer-readable medium may store processor-executable instructions, which, on execution, may cause the processor to provide input data to a quantized large model. The quantized large model is obtained from an large model through quantization aware training based on a quantization technique and the quantized large model may include a plurality of bit-linear layers, each configured for performing a predefined rule-based linear operation. The processor-executable instructions, on execution, may further cause the processor to retrieve a plurality of encoded parameter file for the quantized large model in response to receiving the input data. The plurality of encoded parameters correspond to the plurality of quantized parameters. The processor-executable instructions, on execution, may further cause the processor to process, via the plurality of bit-linear layers, the input data through the associated predefined rule-based linear operation based on the plurality of encoded parameters in the encoded parameter file. The processor-executable instructions, on execution, may further cause the processor to generate, via the quantized large model, an output corresponding to the input data based on the processing

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for processing data through quantized large models, in accordance with some embodiments.

FIG. 2 illustrates a functional block diagram of a memory of a computing device configured to process data through quantized large models, in accordance with some embodiments.

FIG. 3 illustrates a flow chart of an exemplary process for creating an encoded parameter file through Quantization Aware Training (QAT), in accordance with some embodiments.

FIG. 4 illustrates a flow chart of an exemplary process for processing data through quantized large models, in accordance with some embodiments.

FIG. 5 illustrates a flow chart of a detailed exemplary process for processing data through quantized large models, in accordance with some embodiments.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

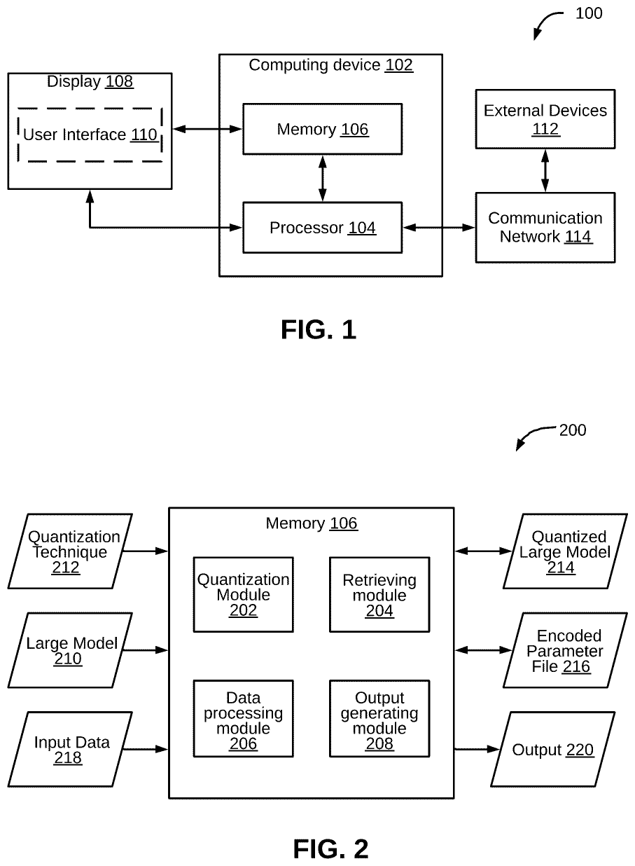

Referring now to FIG. 1, an exemplary system 100 for processing data through quantized large models is illustrated, in accordance with some embodiments. The system 100 may include a computing device 102 (for example, a server, a desktop, a laptop, a notebook, a netbook, a tablet, a smartphone, a mobile phone, or any other computing device), in accordance with some embodiments of the present disclosure. The computing device 102 may be configured to prepare quantized large models from large models. By way of an example, the large models may include, but may not be limited to Large Language Models (for example, Generative Pre-trained Transformer (GPT)-3, GPT-3.5, GPT-4, Language Model for Dialogue Applications (LaMDA), Pathways Language Model (PaLM), BigScience Large Open-science Open-access Multilingual Language Model (BLOOM), Large Language Model Meta AI (Llama), Mistral 7B, Mixtral 8×7B, Mixtral 8×22B, etc.) and multimodal models (for example, DALL-E, Large Language and Vision Assistant (LLaVA), GPT-40, Gemini, Claude 3, etc.). Further, the computing device 102 may be configured to process input data through the quantized large models.

As will be described in greater detail in conjunction with FIGS. 2-6, the computing device 102 may provide input data to a quantized large model. The quantized large model may be obtained from a large model through Quantization Aware Training (QAT) based on a quantization technique (such as 1 bit quantization technique or 1.58 bit quantization technique). QAT is a training method that aims to minimize accuracy degradation resulting from quantization of the large model. The quantized large model may include a plurality of bit-linear layers, each configured for performing a predefined rule-based linear operation. The computing device 102 may further include retrieving encoded parameters from a pre-stored encoded parameter file for the quantized large model in response to receiving the input data. The encoded parameters correspond to the plurality of quantized parameters. The computing device 102 may further include processing, via the plurality of bit-linear layers, the input data through the associated predefined rule-based linear operation based on the plurality of encoded parameters in the encoded parameter file. The computing device 102 may further generate, via the quantized large model, an output corresponding to the input data based on the processing.

In some embodiments, the computing device 102 may include one or more processors 104 and a memory 106. The memory 106 may store instructions that, when executed by the one or more processors 104, cause the one or more processors 104 to process data through quantized large models, in accordance with aspects of the present disclosure. The memory 106 may also store various data (for example, input data, a pre-stored encoded parameter file, a plurality of encoded parameters, and the like) that may be captured, processed, and/or required by the computing device 102.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of the memory 106 of the computing device 102 configured to process data through quantized large models is illustrated, in accordance with some embodiments. FIG. 2 is explained in conjunction with FIG. 1. The computing device 102 may be deployed via a system 200 (analogous to the system 100). The memory 106 may include a quantization module 202, a retrieving module 204, a data processing module 206, and an output generating module 208.

The quantization module 202 may receive a large model 210 and a user selection of a quantization technique 212 (for example, 1 bit quantization technique or 1.58 bit quantization technique) for the large model 210 from a user. The large model 210 may include a plurality of linear layers, a plurality of parameters (for example, weights) in each of the plurality of linear layers, and an associated data type of each of the plurality of parameters. It should be noted that the associated data type of each of the plurality of parameters of the large model 210 is a first data type. The quantization module 202 may train the large model 210 using QAT. The QAT may enable the large model 210 to adapt to the lower precision data type representation while preserving performance.

For QAT, the quantization module 202 may replace the plurality of linear layers of the large model 210 with the corresponding bit-linear layers to obtain a quantized large model 214. Each of the plurality of bit-linear layers may be configured to store parameters in lower precision (example Int8, FP8). Additionally, to obtain the quantized large model 214, the quantization module 202 may transform the associated data type of each of the plurality of parameters (i.e., the first data type) of the large model 210 to a second data type based on the quantization technique 212 to obtain a plurality of quantized parameters. In other words, during QAT, the weight values and the activation values may be quantized (e.g., transformed to 8 bit) in forward pass to mimic real-world deployment scenarios. Gradients may be computed with respect to full-precision weights using techniques such as Straight-Through Estimator (STE) to handle non-differentiable quantization functions.

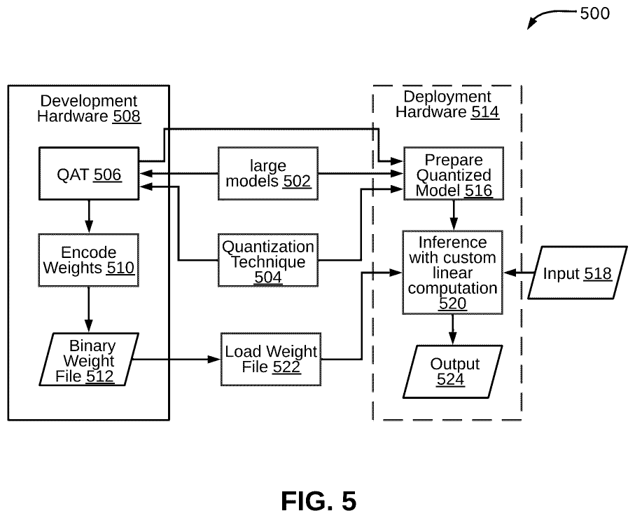

The second data type may be based on the minimum supported data type by hardware and software framework. It should be noted that the second data type is a lower precision data type compared to the first data type. By way of an example, the first data type may be 32 bit floating point (float32). Upon quantization, each of the plurality of parameters may be transformed from float32 data type to either float32, float16, float8, or int8, depending upon the minimum data type supported by the computing device 102 to obtain the plurality of quantized parameters. In an embodiment based on the 1 bit quantization technique, each of the plurality of quantized parameters of the quantized large model 214 may correspond to one of a positive integer or a negative integer. In another embodiment based on the 1.58 bit quantization technique, the each of the plurality of quantized parameters of the quantized large model 214 may correspond to one of a positive integer, a zero bit, or a negative integer. In other words, if the quantization technique 212 is the 1 bit quantization technique, each of the plurality of parameters may be transformed to either +1 (i.e., positive integer) or −1, based on the value of the parameter. If the quantization technique 212 is the 1.58 bit quantization technique, each of the plurality of parameters may be transformed to either +1, 0, or −1, based on the value of the parameter. This is explained in greater detail in conjunction with FIG. 5. These transformed parameters (or quantized parameters) are stored as the second data type.

However, if these quantized parameters are used, the computation may occur using the quantized parameter values in the second data type (i.e., float32, float 16, float8, or int8), and not in 1 bit data type for compatibility with existing hardware and software frameworks. To overcome this limitation, the quantization module 202 may create an encoded parameter file 216 including a plurality of encoded parameters corresponding to the plurality of quantized parameters. The quantization module 202 may transform the associated data type of each of the plurality of quantized parameters from the second data type to a third data type to obtain the plurality of encoded parameters. Each of the plurality of encoded parameters is of a lower precision data type than each of the corresponding plurality of quantized parameters. In an embodiment, the third data type may be a 1 bit or a 2 bit binary value. When a quantized parameter corresponds to the positive integer, a corresponding encoded parameter may be stored as a first binary value. When the quantized parameter corresponds to the negative integer, the corresponding encoded parameter may be stored as a second binary value. Optionally, when the quantized parameter corresponds to zero bit, the corresponding encoded parameter may be stored as a third binary value.

In other words, in case of the 1 bit quantization technique, the quantized parameters with value −1 may be encoded as 1 (i.e., the second binary value) and the quantized parameters with value +1 may be encoded as 0 (i.e., the first binary value). In case of 1.58 bit quantized technique, the quantized parameters values are encoded in 2 bits. Thus, the quantized parameters with value −1 may be encoded as 11 (i.e., the second binary value), the quantized parameters with value +1 may be encoded as 01 (i.e., the first binary value), and the quantized parameters with value 0 may be encoded as 00 (i.e., the third binary value).

Further, the quantization module 202 may store the plurality of encoded parameters in an encoded parameter file 216 (or a binary weight file). Thus, the plurality of quantized parameters may not be directly replaced with the plurality of encoded parameters in the large model. In an embodiment, the QAT and the creation of the encoded parameter file 216 may be a development phase of the system 200.

During a deployment phase, the quantized large model 214 and the encoded parameter file 216 may be deployed in a computing device. In an embodiment, the development phase and the deployment phase may be implemented in two different (but analogous) computing devices. Alternatively, the development phase and the deployment phase may be implemented in the same computing device 102. The quantization module 202 may receive input data 218 from a user It should be noted that the input data 218 may be provided in a higher precision data type (such as float32). Further, the quantization module 202 may provide the input data 218 to the quantized large model 214.

Further, the quantization module 202 may send the input data 218 to the data processing module 206. Additionally, in response to receiving the input data 218, the retrieving module 204 may retrieve a plurality of encoded parameters from a pre-stored encoded parameter file 216 for the quantized large model 214. The retrieving module 204 may then send the plurality of encoded parameters to the data processing module 206.

The data processing module 206 may process, via the quantized large model 214, the input data 218 based on the plurality of encoded parameters in the encoded parameter file 216. Traditional quantized large models process the input data through complex arithmetic operations such as multiplication, which consumer higher memory bandwidth. To process the input data 218 without such complex arithmetic operations, the data processing module 206, via each of the plurality of bit-linear layers of the quantized large model 214, may perform the predefined rule-based linear operations on the input data 218 based on the plurality of encoded parameters.

The input data 218 may include a plurality of input data elements. For each input data element of the plurality of input data elements, when the input data element is processed by a corresponding bit-linear layer, the data processing module 206 may manage a binary sign bit of the input data element based on a corresponding encoded parameter associated with the bit-linear layer. To manage the binary sign bit, the data processing module 206 may retain the binary sign bit of the input data element when the corresponding encoded parameter is stored as the first binary value. Alternatively, the data processing module 206 may modify the binary sign bit when the corresponding encoded parameter is stored as the second binary value. This is discussed in greater detail in conjunction with FIG. 5.

Further, the output generating module 208 may generate, via the quantized large model 214, an output 220 corresponding to the input data 218 based on the processing. To generate the output 220, the output generating module 208 may compute a summation of each of the plurality of input data elements upon completion of managing the associated binary sign bit. Thus, the system 200 overcomes the problem of accuracy degradation through QAT. The system 200 stores the parameters in 1 bit or 2 bit format in the encoded parameter file 216, thus providing efficient storage management. The system 200 also avoids the use of complex arithmetic operations (such as multiplication) when processing the input data 218 by using rule-based linear operations.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for processing data through quantized large models. For example, the exemplary system 100 and the associated computing device 102 may process data through quantized large models by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

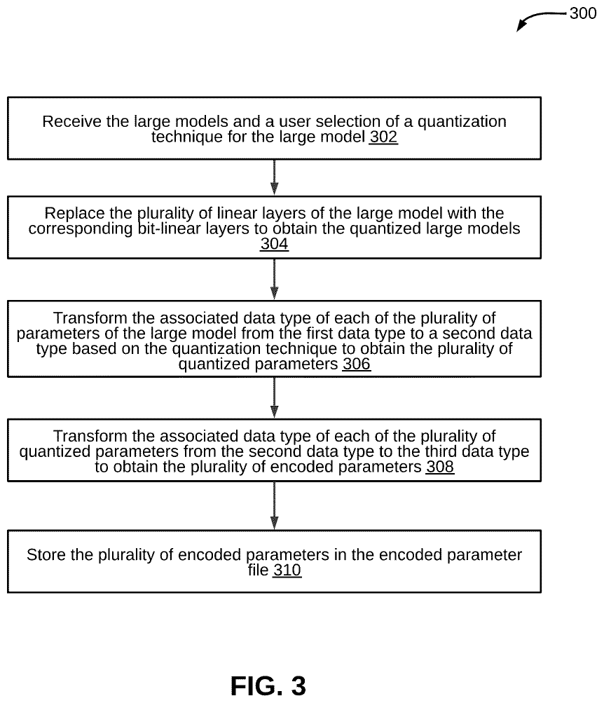

Referring now to FIG. 3, an exemplary process 300 for creating an encoded parameter file through QAT is depicted via a flowchart, in accordance with some embodiments. FIG. 3 is explained in conjunction with FIGS. 1 and 2. The process 300 may be implemented by the computing device 102 of the system 100. The process 300 may include receiving, by a quantization module (for example, the quantization module 202), a large model (for example, the large model 210) and a user selection of a quantization technique (for example, the quantization technique 212) for the large model, at step 302. The large model may include a plurality of linear layers and a plurality of parameters associated with the plurality of linear layers. Each of the plurality of linear layers may include an associated data type. The associated data type of each of the plurality of parameters of the large model is a first data type.

Further, the process 300 may include replacing, by the quantization module, the plurality of linear layers of the large model with the corresponding bit-linear layers to obtain a quantized large model (for example, the quantized large model 214), at step 304. Further, the process 300 may include transforming, by the quantization module, the associated data type of each of the plurality of parameters of the large model from the first data type to a second data type based on the quantization technique to obtain a plurality of quantized parameters, at step 306. Each of the plurality of quantized parameters of the quantized large model is a lower precision data type than each of the plurality of parameters of the large model. The second data type may be a lower precision data type compared to the first data type. Each of the plurality of quantized parameters of the quantized large model corresponds to one of a positive integer or a negative integer.

Further, the process 300 may include transforming, by the quantization module, the associated data type of each of the plurality of quantized parameters from the second data type to the third data type to obtain the plurality of encoded parameters, at step 308. Each of the plurality of encoded parameters is of lower precision data type than each of the corresponding plurality of quantized parameters. When a quantized parameter corresponds to the positive integer, a corresponding encoded parameter is stored as a first binary value. When the quantized parameter corresponds to the negative integer, the corresponding encoded parameter is stored as a second binary value. Further, the process 300 may include storing, by the quantization module, the plurality of encoded parameters in the encoded parameter file, at step 310.

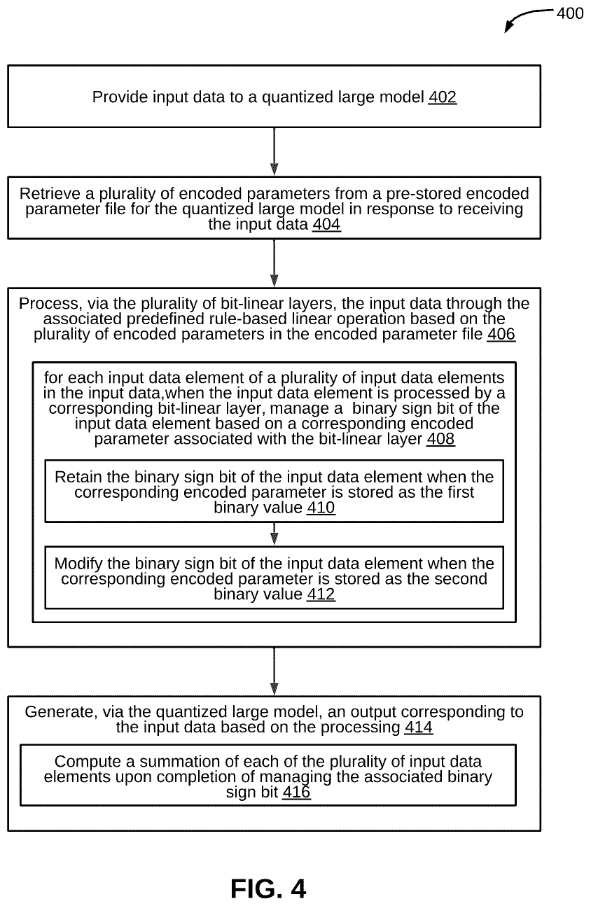

Referring now to FIG. 4, an exemplary process 400 for processing processing data through quantized large models (for example, the quantized large model 214) is depicted via a flowchart, in accordance with some embodiments. FIG. 4 is explained in conjunction with FIGS. 1, 2, and 3. The process 400 may be implemented by the computing device 102 of the system 100. The process 400 may include providing, by a data processing module (for example, the data processing module 206), input data (for example, the input data 218) to a quantized large model (for example, the quantized large model 214), at step 402. The quantized large model is obtained from a large model through QAT based on a quantization technique. The quantized large model may include a plurality of bit-linear layers, each configured for performing a predefined rule-based linear operation. This has already been discussed in conjunction with FIG. 3, and is discussed in greater detail in conjunction with FIG. 5.

Further, the process 400 may include retrieving, by a retrieving module (for example, the retrieving module 204), the encoded parameters from a pre-stored encoded parameter file (for example, the encoded parameter file 216) for the quantized large model in response to receiving the input data, at step 404. The encoded parameters correspond to the plurality of quantized parameters. Further, the process 400 may include processing, by a data processing module (for example, the data processing module 206) via the plurality of bit-linear layers, the input data through the associated predefined rule-based linear operation based on the plurality of encoded parameters in the encoded parameter file, at step 406. The step 406 may include step 408. For each input data element of a plurality of input data elements in the input data, when the input data element is processed by a corresponding bit-linear layer, the process 400 may include managing, by the data processing unit, a binary sign bit of the input data element based on a corresponding encoded parameter associated with the bit-linear layer, at step 408. The step 408 may include steps 410 and step 412. The process 400 may include retaining, by the data processing module, the binary sign bit of the input data element when the corresponding encoded parameter is stored as the first binary value, at step 410. The process 400 may include modifying, by the data processing module, the binary sign bit of the input data element when the corresponding encoded parameter is stored as the second binary value, at step 412.

Further, the process 400 may include generating, by an output generating module (for example, the output generating module 208) via the quantized large model, an output corresponding to the input data based on the processing, at step 414. The step 414 may include step 416. Further, the process 400 may include computing, by the output generating module, a summation of each of the plurality of input data elements upon completion of managing the associated binary sign bit, at step 416.

Referring now to FIG. 5, a detailed exemplary process 500 for processing data through quantized large models (for example, the quantized large model 214) is depicted via a flowchart, in accordance with some embodiments. FIG. 5 is explained in conjunction with FIGS. 1-4. The process 500 may be implemented by the computing device 102 of the system 100. The process 500 may include receiving, by the quantization module 202, an large model 502 and a quantization technique 504 as an input from a user. The large model 502 may be analogous to the large model 210 and the quantization technique 504 may be analogous to the quantization technique 212. The large model 502 may include a plurality of linear layers. Each of the plurality of linear layers may include a plurality of neurons. The plurality of neurons may include a plurality of associated parameters. Each of the plurality of parameters may include an associated data type. The associated data type of each of the plurality of parameters of the large model 502 is a first data type.

The quantization technique 504 may be one of a 1 bit quantization technique or a 1.58 bit quantization technique. The 1 bit quantization algorithm may binarize the plurality of parameters (W) to either +1 or −1 using the signum function described through equations (1) and equation (2).

$$\tilde{W} = Sign ( W - α ) \qquad ( 1 )$$

$$Where , Sign ( {W}_{ij} ) = \{ \begin{matrix}+ 1 , & if {W}_{ij} > 0 \\ - 1 , & if {W}_{ij} \leq 0 ,\end{matrix}$$

$$α = \frac{1}{nm} {Σ}_{ij} {W}_{ij} \qquad ( 2 )$$

The 1.58 bit quantization technique may use 1.58 bits per parameter. Upon quantization through the 1.58 but quantization technique, each of the plurality of quantized parameters may be one of three possible values, i.e., −1, 0, 1.

Further, the process 500 may include performing, by the quantization module 202, a QAT 506 of each of the plurality of parameters on a development hardware 508. The development hardware may be analogous to the computing device 102. The QAT 506 may include loading the large model 502 into memory (for example, the memory 106). Further, the QAT 506 may include replacing the plurality of linear layers of the large model 502 with a plurality of bit-linear layers. Further, the QAT 506 may include transforming the associated data types of each of the plurality of parameters of the large model 502 from the first data type to a second data type through the quantization technique 504 to obtain the plurality of quantized parameters. The second data type may be based on the lowest precision data type supported by the development hardware 508.

Further, the process 500 may include transforming, by the quantization module 202, the second data type to a third data type (binary format) to obtain a plurality of encoded parameters. In other words, the process 500 may include encoding weights (float/integer) into binary format (1- or 2-bit representations) using bit array package to obtain the plurality of encoded parameters, at step 510. Further, the process 500 may include storing, by the quantization module 202, the plurality of encoded parameters in a binary weight file 512 (i.e., an encoded parameter file).

Further, the large model 502 is loaded on a deployment hardware 514. The deployment hardware 514 may be analogous to the computing device 102. Further, the process 500 may include preparing, by the quantization module 202, a quantized model (analogous to the quantized large model 214) from the large model, at step 516. Preparing the quantized model may include replacing the plurality of linear layers with a plurality of bit linear layer. The plurality of bit-linear layers may include a plurality of neurons and quantized weights associated with the plurality of neurons. The bit linear layer may incorporate a custom linear computation process. The custom linear layer may achieve linear computation through simple addition (and subtraction) operations, without the need for multiplication.

Further, the process 500 may include inferencing, via the quantized model, input data 518, at step 520. Inferencing may include loading, by the retrieving module 204, the binary weight file 512 in the deployment hardware 514, at step 522. Further, the process 500 may include processing, by the data processing module 206, via the plurality of bit-linear layers, the input data 518 through the associated predefined rule-based linear operation based on the plurality of encoded parameters in the binary weight file 512. In other words, the contribution of the encoded weights towards processing the input data 518 is determined based on predefined rules, instead of multiplication. Further, the contribution of each weight is summed. Further, the process 500 may include generating, by the output generating module 208 via the quantized model, a quantized model output 524 corresponding to the input data 518 based on the processing.

By way of an example, the large model 502 may include the plurality of parameters. Each of the plurality of parameters may include an associated data type of each of the plurality of parameters. Each of the plurality of parameters may be stored in float32 data type (32 bit format). Thus, the bit size for each weight may be 32 bits (or 4 bytes per weight). Number of weights may be, for example, 7 billion (i.e., 7×10\hat{ }9). Thus, memory required (in bytes) to store the large model 502 may be 28 GB (7×10\hat{ }9×32/8=28×10\hat{ }9 bytes).

On the other hand, when the large model 502 is quantized to obtain the quantized large model with the plurality of quantized parameters stored in int8 data type (8 bit format), the bit size for each weight may be 8 bits (or 1 bytes per weight). Thus, memory required (in bytes) to store the quantized large model may be 7 GB (7×10\hat{ }9×8/8=7×10\hat{ }9 bytes). Thus, the memory required to store the quantized large model is much less than the memory required to store the large model 502.

By way of an example, a large model may include 4096 input neurons and 4096 output neurons. Thus, total parameters may be 16, 777, 216. When the plurality of parameters is in the float32 data type, the bits required to store the parameters may be 536, 870, 912 bits (i.e., 16,777,216×32). Bits required to store input and output may be 262,144 (i.e., (4096×32)+(4096×32)). Bits required for linear computation 537,133,056 bits (or 64.03 MB).

When the plurality of parameters of the same large model is in 1 bit data type, bits required to store the parameters may be 16,777,216 (i.e., 16,777,216×1). Bits required to store input and output may be 262,144 (i.e., (4096×32)+(4096×32)). Bits required for linear computation may be 17,039,360 bits (or 2.03 MB). Thus, memory consumption when processing input data through the large model with 1 bit weights is far less than the memory consumption through the large model with higher precision weights.

By way of an example, a 3×1 neural network with 1 bit encoded weights may receive an input in float32 (32-bit floating point) format. The weights of the neural network are binary encoded. That is to say, a weight of +1 is encoded as 0 and a weight of −1 is encoded as 1. To compute the contribution based on weight values without multiplying the input by the corresponding weight, the neural network may implement a weight encoding logic (i.e., a predefined rule-based linear operation). Based on the weight encoding logic, a weight with binary value 0 corresponds to +1 contribution (i.e., no change to the sign bit of the input data). Additionally, a weight with binary value 1 corresponds to −1 contribution (i.e., sign inversion of the sign bit of the input data). The output may be a sum of the contributions of each of the plurality of weights as described by equation (3).

$${Output}_{j} = {\sum }_{i = 1}^{3} {Contribution}_{ij}$$

For example, an input data vector may be [1.5, −2.3, 0.7]. Quantized weight values (in int8 format) may be [−1, +1, −1]. Thus, encoded binary weights corresponding to the quantized weight values for a single neuron may be [1, 0, 1].

The contribution breakdown in the above example is provided through Table 1 below.

TABLE 1
Exemplary contribution breakdown of a 1 bit
large model when inferencing input data.

| INPUT | WEIGHT | CONTRIBUTION CALCULATION | RESULT |
|---|---|---|---|
| 1.5 | 1 | −1.5 (sign flip) | −1.5 |
| −2.3 | 0 | −2.3 (no change) | −2.3 |
| 0.7 | 1 | −0.7 (sign flip) | −0.7 |

Output of the neuron may be a sum of the result column. Thus, the output may be −1.5+(−2.3)+(−0.7)=−4.5.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

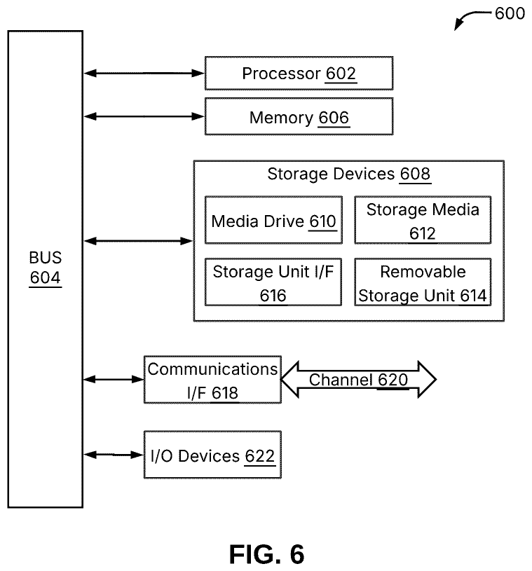

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem of processing data through quantized large models. The disclosed method and system may provide input data to a quantized large model. The quantized large model may be obtained from an large model through quantization aware training based on a quantization technique. The quantized large model may include a plurality of bit-linear layers, each configured for performing a predefined rule-based linear operation. The disclosed method and system may further retrieve a plurality of encoded parameters from a pre-stored encoded parameter file for the quantized large models in response to receiving the input data. The plurality of encoded parameters corresponds to the plurality of quantized parameters. Further, the disclosed method and system may process, via the plurality of bit-linear layers, the input data through the associated predefined rule-based linear operation based on the plurality of encoded parameters in the encoded parameter file. Further, the disclosed method and system may generate, via the quantized large model, an output corresponding to the input data based on the processing.

As will be appreciated by those skilled in the art, the techniques described in the various embodiments discussed above are not routine, or conventional, or well understood in the art. The techniques may perform a Quantization-Aware Training (QAT). The QAT may align with 8-bit or 16-bit precision to optimize hardware utilization (GPUs, TPUs) while preserving accuracy and preparing weights for binary quantization. The techniques may include efficient weight storage. The techniques may store weights as binary files, enabling lightweight, hardware-friendly transmission and reducing communication latency in distributed setup of the architecture. Further, the techniques may include replacing the matrix multiplication operations by simple addition (and subtraction) operations. The techniques may provide the new architecture strong memory and computational cost savings.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for processing data through quantized large models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for processing data through quantized large models, the method comprising:
providing, by a computing device, input data to a quantized large model, wherein:
the quantized large model is obtained from a large model through quantization aware training based on a quantization technique, and
the quantized large model comprises a plurality of bit-linear layers, each configured for performing a predefined rule-based linear operation, and a plurality of quantized parameters;
retrieving, by the computing device, a plurality of encoded parameters from a pre-stored encoded parameter file for the quantized large model in response to receiving the input data, wherein the plurality of encoded parameters corresponds to the plurality of quantized parameters,
processing, by the computing device via the plurality of bit-linear layers, the input data through the associated predefined rule-based linear operation based on the plurality of encoded parameters in the encoded parameter file; and
generating, by the computing device via the quantized large model, an output corresponding to the input data based on the processing.

2. The method as claimed in claim 1, wherein each of the plurality of quantized parameters of the quantized large model is of a lower precision data type than each of a plurality of parameters of the large model, wherein each of the plurality of encoded parameters is of a lower precision data type than each of the corresponding plurality of quantized parameters.

3. The method as claimed in claim 1, wherein each of the plurality of quantized parameters of the quantized large model corresponds to one of a positive integer or a negative integer, wherein when a quantized parameter corresponds to the positive integer, a corresponding encoded parameter is stored as a first binary value, and wherein when the quantized parameter corresponds to the negative integer, the corresponding encoded parameter is stored as a second binary value.

4. The method as claimed in claim 3, wherein processing the input data comprises:
for each input data element of a plurality of input data elements in the input data,
when the input data element is processed by a corresponding bit-linear layer, managing a binary sign bit of the input data element based on a corresponding encoded parameter associated with the bit-linear layer, wherein the managing comprises, one of:
retaining the binary sign bit of the input data element when the corresponding encoded parameter is stored as the first binary value; or
modifying the binary sign bit of the input data element when the corresponding encoded parameter is stored as the second binary value.

5. The method as claimed in claim 4, wherein generating the output comprises computing a summation of each of the plurality of input data elements upon completion of managing the associated binary sign bit.

6. The method as claimed in claim 1, wherein obtaining the quantized large model comprises:
receiving the large model and a user selection of a quantization technique for the large model, wherein an associated data type of each of a plurality of parameters of the large model is a first data type;
replacing a plurality of linear layers of the large model with the corresponding bit-linear layers to obtain the quantized large model; and
transforming the associated data type of each of the plurality of parameters of the large model from the first data type to a second data type based on the quantization technique to obtain the plurality of quantized parameters, wherein the second data type is a lower precision data type compared to the first data type.

7. The method as claimed in claim 6, further comprising:
transforming the associated data type of each of the plurality of quantized parameters from the second data type to a third data type to obtain the plurality of encoded parameters; and
storing the plurality of encoded parameters in the encoded parameter file.

8. A system for processing data through quantized large models, the system comprising:
a processor; and
a memory communicatively coupled to the processor, wherein the memory stores processor instructions, which when executed by the processor, cause the processor to:
provide, input data to a quantized large model, wherein:
the quantized large model is obtained from a large model through quantization aware training based on a quantization technique, and
the quantized large model comprises a plurality of bit-linear layers, each configured for performing a predefined rule-based linear operation, and a plurality of quantized parameters;
retrieve a plurality of encoded parameters from a pre-stored encoded parameter file for the quantized large model in response to receiving the input data, wherein the plurality of encoded parameters corresponds to the plurality of quantized parameters;
process, via the plurality of bit-linear layers, the input data through the associated predefined rule-based linear operation based on the plurality of encoded parameters in the encoded parameter file; and
generate, via the quantized large model, an output corresponding to the input data based on the processing.

9. The system as claimed in claim 8, wherein each of the plurality of quantized parameters of the quantized large model corresponds to one of a positive integer or a negative integer, wherein when a quantized parameter corresponds to the positive integer, a corresponding encoded parameter is stored as a first binary value, and wherein when the quantized parameter corresponds to the negative integer, the corresponding encoded parameter is stored as a second binary value.

10. The system as claimed in claim 9, wherein to process the input data, the processor instructions, on execution, cause the processor to:
for each input data element of a plurality of input data elements in the input data,
when the input data element is processed by a corresponding bit-linear layer, manage a binary sign bit of the input data element based on a corresponding encoded parameter associated with the bit-linear layer, wherein the managing comprises, one of:
retain the binary sign bit of the input data element when the corresponding encoded parameter is stored as the first binary value; or
modify the binary sign bit of the input data element when the corresponding encoded parameter is stored as the second binary value, wherein to generate the output, the processor instructions, on execution, cause the processor to compute a summation of each of the plurality of input data elements upon completion of managing the associated binary sign bit.
